(19) United States
(12) Patent Application Publication
(10) Pub. No.: US 2012/0249436 A1
(43) Pub. Date: Oct. 4, 2012

(54) Liquid Crystal Display Apparatus with In Touch Sensor and Manufacturing Method Thereof

(75) Inventors: Jin Wook Choi, Seoul (KR); Hyoung Jin Yoon, Seoul (KR)

(73) Assignee: HYDIS TECHNOLOGIES CO., LTD., Seoul (KR)

(21) Appl. No.: 13/215,685

(22) Filed: Aug. 23, 2011

(30) Foreign Application Priority Data
Mar. 28, 2011 (KR) 1020110027544

(51) Int. Cl. G06F 3/041; H01J 9/00

(52) U.S. Cl. 345/173; 445/24

(57) ABSTRACT

Disclosed is a liquid crystal display (LCD) apparatus with a built-in touch sensor, the LCD apparatus including: a first substrate and a second substrate placed facing each other with a liquid crystal layer interposed therebetween; a plurality of gate lines and a plurality of data lines arranged to intersect each other and defined a pixel region on the first substrate; a plurality of first touch signal lines formed on a surface of the second substrate opposite to the first substrate substantially corresponding to the respective gate lines; a plurality of second touch signal lines formed on the surface of the second substrate substantially corresponding to the respective data lines while being insulated from and intersecting with the first touch signal lines; and a color filter formed on the surface of the second substrate substantially corresponding to the pixel region, wherein the first touch signal lines and the second touch signal lines serve as a signal line for sensing touch as well as a light shielding member.

### CROSS-REFERENCE TO RELATED APPLICATION

This application claims priority to and the benefit of Korean Patent Application No. 10-2011-0027544 filed in the Korean Intellectual Property Office on Mar. 28, 2011, the entire contents of which are incorporated herein by reference.

### BACKGROUND OF THE INVENTION

(a) Field of the Invention

The present invention relates to a liquid crystal display (LCD) apparatus with a built-in touch sensor, and more particularly, to an LCD apparatus with a built-in touch sensor, in which sensing lines are formed at a position for a conventional black matrix formed in a light shielding region and serve as both a light shielding member and a touch sensor to improve transmittance.

(b) Description of the Related Art

Generally, an LCD apparatus is a display apparatus in which liquid crystal is injected as an intermediated material between solid and liquid into a space between two substrates, and an effect of light and shadow is generated to display an image by molecular arrangement of the liquid crystal varied depending on an electric field formed between electrodes provided in the two substrate. The LCD apparatus has been widely used for an electronic clock, an electronic calculator, a personal computer (PC), a television (TV), etc.

Recently, demands on an LCD apparatus with a built-in touch sensor, where touch panel technology is combined to the LCD apparatus, have being rapidly increased for the use of vehicle installation, etc. Accordingly, researches have been actively carried out to improve the performance of the LCD apparatus with the built-in touch sensor.

Here, the touch panel technology is technology that allows a user to control a system by touching a transparent surface provided on a display screen with a pen, a finger or the like.

The kind of the LCD apparatus with the built-in touch sensor is representatively divided into a resistive type, a capacitive type, etc.

In the case of the resistive type, first and second sensing electrodes are respectively formed on opposite surfaces of first and second substrates opposite to each other, and a contact position is detected on the basis of resistance varied depending on the contact positions between the first and second sensing electrodes when the second substrate is pressed.

In the case of the capacitive type, the first and second sensing electrodes are formed on one sheet of substrate, and input coordinates are detected by sensing variation in capacitance generated between the two sensing electrodes when a finger or the like touches or approaches.

Since the resistive type is based on physical contact and accurate contact is needed, force of certain strength or more and press of certain depth or more have to be applied for the accurate contact. Accordingly, there are shortcomings that accuracy is deteriorated, detection speed becomes lowered, and it is impossible to detect touches at different positions.

Further, because the substrate is frequently deformed by the press, there is a problem of low durability.

Accordingly, the capacitive type has been most widely used since it has relatively high durability, facilitates multi-touch and has higher detection accuracy.

However, even the capacitive type has a structure where one of the two opposite substrates additionally includes a sensing electrode in X and Y axial direction, and thus there is a problem that transmittance of the LCD apparatus is remarkably lowered. Also, a touch panel is manufactured separately from the LCD apparatus, and thus there are problems of difficulty in a process, increase in production cost, etc.

Further, such a structure increases the thickness of the LCD apparatus, and thus there is a limit to make the LCD apparatus thin.

### SUMMARY OF THE INVENTION

Accordingly, the present invention is conceived to solve the forgoing problems, and an aspect of the present invention is to provide an LCD apparatus with a built-in touch sensor, in which a touch signal line usable as a light shielding member for shielding light and a signal line for sensing touch is formed at a position for a conventional black matrix, thereby enhancing transmittance and simplifying a process.

Another aspect of the present invention is to provide an LCD apparatus with a built-in touch sensor, in which there is no need of a separate touch panel and a LCD panel can be made thin since a touch signal line serves as both a light shielding member and a signal line.

An exemplary embodiment of the present invention provides a liquid crystal display (LCD) apparatus with a built-in touch sensor, the LCD apparatus including: a first substrate and a second substrate placed facing each other with a liquid crystal layer interposed therebetween; a plurality of gate lines and a plurality of data lines arranged to intersect each other and defined a pixel region on the first substrate; a plurality of first touch signal lines formed on a surface of the second substrate opposite to the first substrate substantially corresponding to the respective gate lines; a plurality of second touch signal lines formed on the surface of the second substrate substantially corresponding to the respective data lines while being insulated from and intersecting with the first touch signal fines; and a color filter formed on the surface of the second substrate substantially corresponding to the pixel region, wherein the first touch signal lines and the second touch signal lines serve as a signal line for sensing touch as well as a light shielding member.

The first touch signal line and the second touch signal fine may be respectively formed on different planes with an insulating layer therebetween.

The first touch signal line and the second touch signal line may be formed on the same plane, and one of the first touch signal line and the second touch signal line may be electrically connected by a bridge electrode leaving an insulating layer therebetween in a region where the first touch signal line and the second touch signal line intersect with each other.

The bridge electrode may be formed on a surface of the second substrate opposite to the first substrate, and the first touch signal line and the second touch signal line are formed under the bridge electrode with the insulating layer therebetween.

The first touch signal line and the second touch signal line may be formed on a surface of the second substrate opposite to the first substrate, and the bridge electrode may be formed under the first touch signal line and the second touch signal line with the insulating layer therebetween.

The first touch signal line may be electrically connected to at least one different first touch signal line adjacent thereto to form a first touch signal line group, and the second touch signal line may be electrically connected to at least one different second touch signal line adjacent thereto to form a second touch signal line group.

Another exemplary embodiment of the present invention provides a method of manufacturing a liquid crystal display (LCD) apparatus with a built-in touch sensor, which includes a first substrate and a second substrate placed facing each other with a liquid crystal layer interposed therebetween, and a plurality of gate lines and a plurality of data lines arranged to intersect each other and defined a pixel region on the first substrate, the method including forming a plurality of first touch signal lines by stacking and patterning a transparent conductive layer on a surface of the second substrate opposite to the first substrate substantially corresponding to the respective gate lines; forming an insulating layer to cover the first touch signal line formed on the second substrate;forming a plurality of second touch signal lines by stacking and patterning a transparent conductive layer on the insulating layer corresponding to the respective data lines while intersecting with the first touch signal; and forming a color filter on the surface of the second substrate substantially corresponding to the pixel region.

Still another exemplary embodiment of the present invention provides a method of manufacturing a liquid crystal display (LCD) apparatus with a built-in touch sensor, which includes a first substrate and a second substrate placed facing each other with a liquid crystal layer interposed therebetween, and a plurality of gate lines and a plurality of data lines arranged to intersect each other and defined a pixel region on the first substrate, the method including forming a plurality of bridge electrodes spaced part from each other along a direction of the gate line or the data line by stacking and patterning a conductive film on a surface of the second substrate opposite to the first substrate; forming an insulating layer to cover the bridge electrode and have a contact hole through which opposite sides of the bridge electrode are partially exposed; forming a first touch signal line and a second touch signal line at positions respectively corresponding to the gate line and the data line by stacking and patterning a transparent conductive layer on the insulating layer, wherein one of the first touch signal line and the second touch signal line is segmented with the other one therebetween, and the segmented touch signal lines are connected to the bridge electrode through the contact hole and thus electrically connected to each other; and forming a color filter on the surface of the second substrate substantially corresponding to the pixel region.

Yet another exemplary embodiment of the present invention provides a method of manufacturing a liquid crystal display (LCD) apparatus with a built-in touch sensor, which includes a first substrate and a second substrate placed facing each other with a liquid crystal layer interposed therebetween, and a plurality of gate lines and a plurality of data lines arranged to intersect each other and defined a pixel region on the first substrate, which is opposite to the first substrate with a liquid crystal layer therebetween, the method including forming a plurality of bridge electrodes at regular intervals at positions corresponding to the gate line or the data line by stacking and patterning a conductive film on a surface of the second substrate opposite to the first substrate; forming an insulating layer to cover the bridge electrode while partially exposing opposite sides of the bridge electrode; forming a first touch signal line and a second touch signal line at positions respectively corresponding to the gate line and the data line by stacking and patterning a transparent conductive layer on a surface of the second substrate formed with the insulating layer, wherein one of the first touch signal line and the second touch signal line is segmented with the other one therebetween, and the segmented touch signal lines are electrically connected to each other through the exposed part of the bridge electrode; and forming a color filter on the surface of the second substrate substantially corresponding to the pixel region.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a schematic view of an LCD apparatus with a built-in touch sensor according to a first exemplary embodiment of the present invention;

FIG. 2 is a cross-section view taken along a second touch signal line in FIG. 1;

FIG. 3 is a cross-section view taken along a first touch signal line in FIG. 1;

FIGS. 4 to 7 show manufacturing processes of the LCD apparatus with the built-in touch sensor according to the first exemplary embodiment of the present invention;

FIG. 8 is a schematic view of an LCD apparatus with a built-in touch sensor according to a second exemplary embodiment of the present invention;

FIG. 9 is an enlarged view of ‘A’ in FIG. 8;

FIG. 10 is a cross-section view taken along a gate line in FIG. 8;

FIG. 11 is a schematic view of an LCD apparatus with a built-in touch sensor according to a third exemplary embodiment of the present invention;

FIG. 12 is an enlarged view of ‘B’ in FIG. 8; and

FIG. 13 is a cross-section view taken along a gate line in FIG. 11.

### DETAILED DESCRIPTION OF THE EMBODIMENTS

Prior to description, elements will be representatively explained in an embodiment and only different configurations will be described in another embodiment, in which like reference numerals refer to like elements throughout.

Hereinafter, a liquid crystal display (LCD) apparatus with a built-in touch sensor according to a first exemplary embodiment of the present invention will be described with reference to the accompanying drawings.

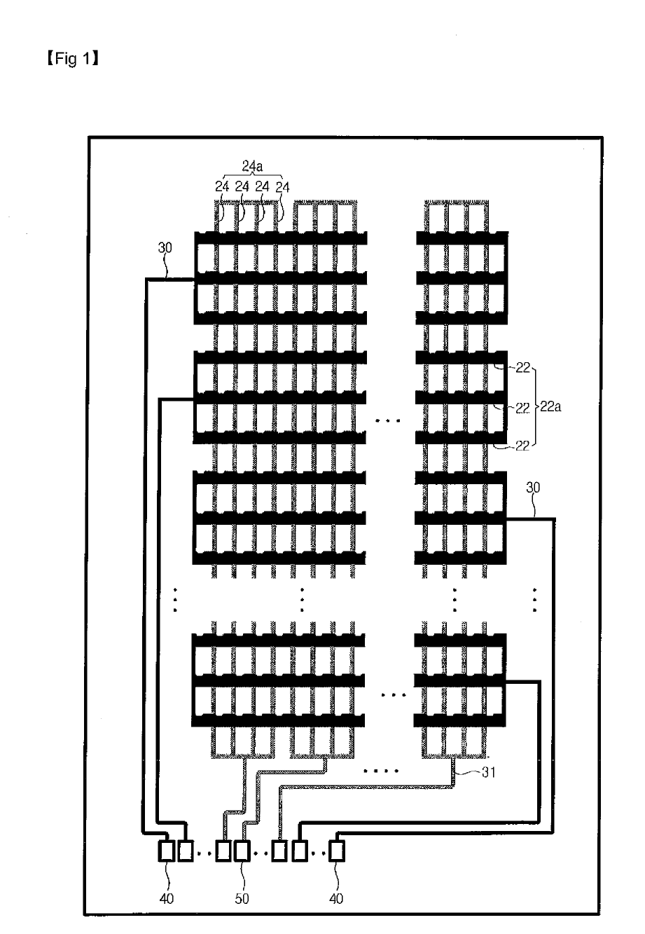

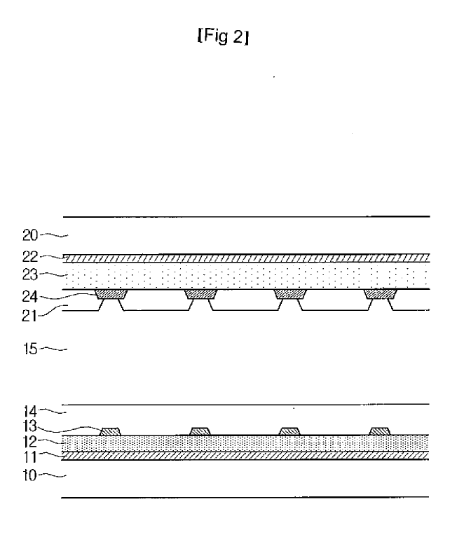

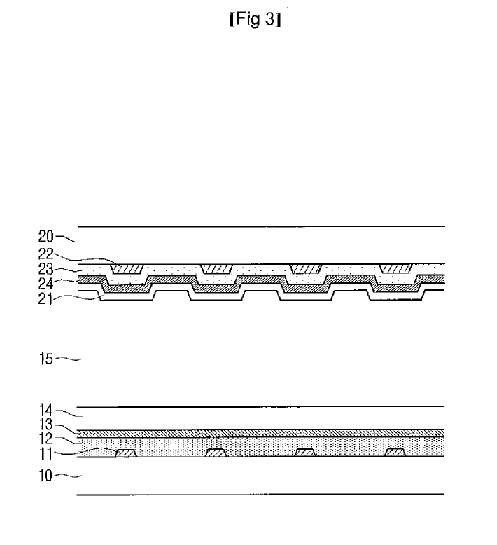

FIG. 1 is a schematic view of an LCD apparatus with a built-in touch sensor according to a first exemplary embodiment of the present invention, FIG. 2 is a cross-section view taken along a second touch signal line in FIG. 1, and FIG. 3 is a cross-section view taken along a first touch signal line in FIG. 1.

Referring to FIGS. 1 to 3, the LCD apparatus with the built-in touch sensor according to the first exemplary embodiment of the present invention includes a first substrate 10, an second substrate 20 opposite to the first substrate 10, and a liquid crystal layer 30A interposed between the first substrate 10 and the second substrate 20.

For example, there will be described a structure where the first substrate 10 is made of glass or the like, and an electrode structure formed on a surface adjacent to the liquid crystal layer 30A is formed on the first substrate 10 of a general fringe field switching (FFS) mode LCD apparatus.

A gate line 11 and a common electrode may be formed on a surface adjacent to the liquid crystal layer 30A of the first substrate 10, and a gate insulating layer 12 may be formed thereon.

Above them, the gate line 11 and a data line 13 may be arranged to intersect each other and define a pixel region, and a pixel electrode may be formed in each pixel region.

Further, a thin film transistor for selectively applying a driving signal to a pixel electrode may be formed in a region where the gate line 11 and the data line 13 intersect each other.

A passivation film 14 may be formed between the data line 13 and the pixel electrode.

The second substrate 20 is made of the same material as the first substrate 10, and arranged opposite the first substrate 10 with the liquid crystal layer 30A therebetween.

On the second substrate 20, a first touch signal line 22 and a second touch signal line 24 are formed in different layers with an insulating layer 23 therebetween.

The first touch signal line 22 may be formed on a surface of the second substrate 20 opposite to the first substrate 10 so as to substantially correspond to the gate line 11.

At this time, the first touch signal line 22 may be made of a metallic material such as chrome (Cr) or the like to serve as a conventional black matrix as well as a signal line for sensing touch.

The second touch signal line 24 may be formed on a surface of the second substrate 20 opposite to the first substrate 10 so as to substantially correspond to the data line 13, and made of the same material as the first touch signal line 10 to do the same function. That is, the first touch signal line 22 is formed substantially corresponding to the gate line 11, and the second touch signal 24 is formed substantially corresponding to the data line 13, thereby serving as a signal line for sensing touch and a conventional black matrix.

Further, a color filter 21 may be formed in a region sectioned by the first touch signal line 22 and the second touch signal line 24 so as to substantially correspond to the pixel region defined by the gate line 11 and the data line 13 of the first substrate 10.

Meanwhile, the first touch signal line 22 is electrically connected to at least one different first touch signal line 22 adjacent to each other to thereby form a first touch signal line group 22a, and the second touch signal line 24 is electrically connected to at least one different second touch signal line 22 adjacent to each other to thereby form a second touch signal line group 24a (refer to FIG. 1).

That is, the first touch signal line group 22a is formed by grouping and electrically connecting a preset number of first touch signal lines adjacent along a direction of the data line 13, and the second touch signal line group 24a is formed by grouping and electrically connecting a preset number of second touch signal lines adjacent along a direction of the gate line 11.

As above, if the touch signal lines are electrically connected in parallel and formed as a kind of group, resistance is substantially lowered to thereby enhance accuracy in detecting touch.

Further, the first touch signal line group 22a and the second touch signal lien group 24a are respectively connected to a first external connector 40 and a second external connector 50 placed outside a display region through a first fan-out wiring line 30 and a second fan-out wiring line 31, and receive driving signals or detect and transmit variance in capacitance between the first touch signal line group 22a and the second touch signal lien group 24a, thereby sensing touch.

Here, the first and second external connectors 40 and 50 may be connected to an external driving circuit provided as a flexible printed circuit (FPC) or the like through a pad and a conductive transfer which may be formed in the first substrate 10.

Through the driving circuit, the driving signal is applied to one of the first touch signal line group 22a and the second touch signal line group 24a, and a touching position can be ascertained on the basis of variance in capacitance transmitted from the other touch signal line.

In the foregoing exemplary embodiment, the first touch signal line 22 and the second touch signal line 24 respectively form the first touch signal line group 22a and the second touch signal line group 24a and are then electrically connected to the first external connector 40 and the second external connector 50, but not limited thereto. Alternatively, the first touch signal line 22 and the second touch signal line 24 may be directly connected to the first external connector 40 and the second external connector 50, respectively.

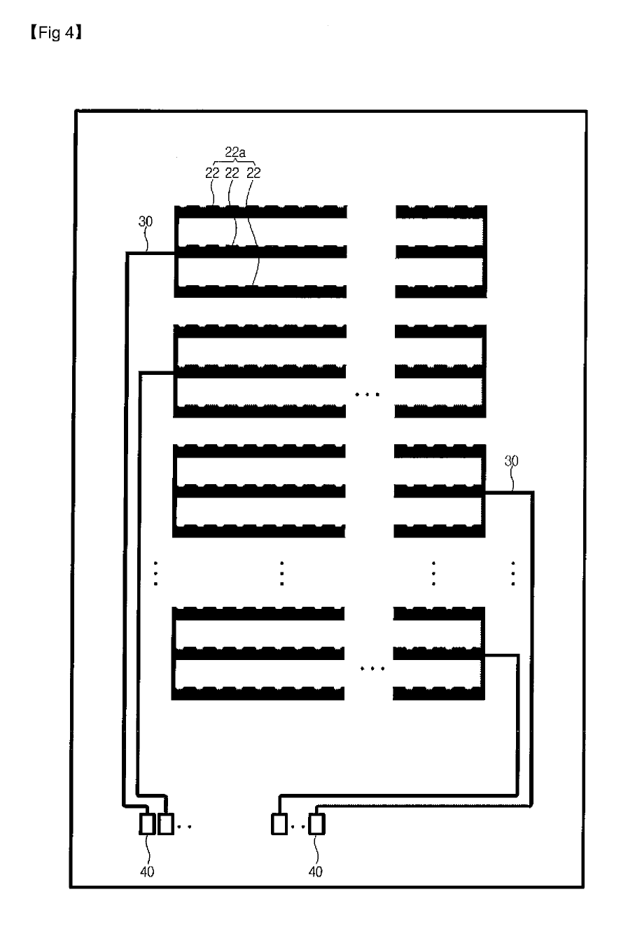

Below, a manufacturing method of the LCD apparatus with the built-in touch sensor according to the first exemplary embodiment of the present invention will be described with reference to FIGS. 4 to 7. In this manufacturing is method, a manufacturing method of the electrode structure of the second substrate will be described according to an exemplary embodiment of the present invention.

Referring to FIG. 4, a metal film is formed on one surface of the second substrate 20 and patterned to form the first touch signal line 22 at a position corresponding to the gate line 11 formed in the first substrate 10, and the first external connector 40 is formed outside the display region. Further, the first fan-out wiring line 30 is formed to electrically connect the first touch signal line 22 with the first external connector 40.

At this time, a preset number of first touch signal lines 22 are grouped and electrically connected to thereby form the first touch signal line group 22a.

The first fan-out wiring line 30 may be extended so that a first end thereof can be electrically connected to the first touch signal line 22 and a second end thereof can be electrically connected to the first external connector 40.

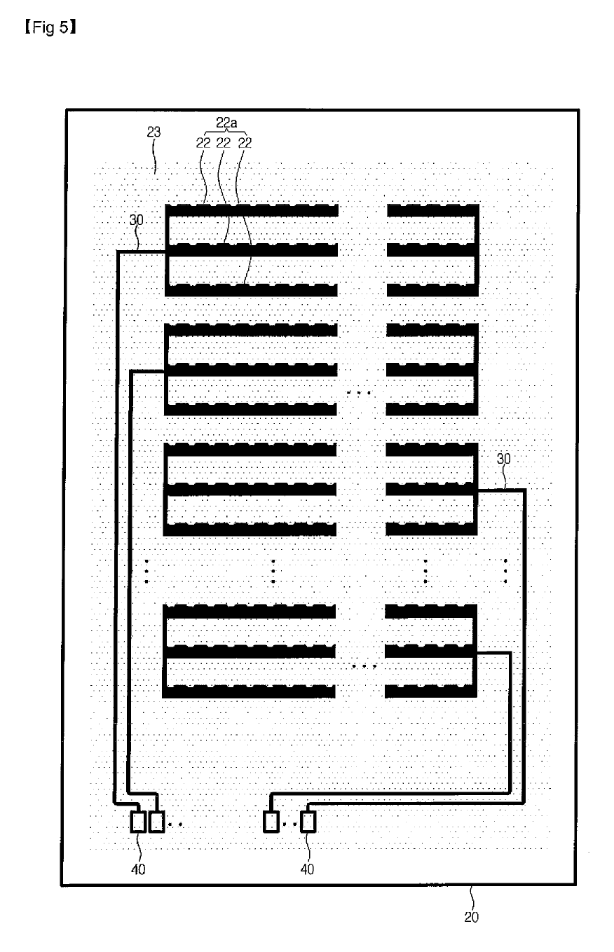

Then, as shown in FIG. 5, the insulating layer 23 is formed to cover the first touch signal line 22, the first fan-out wiring line 30 and the first external connector 40.

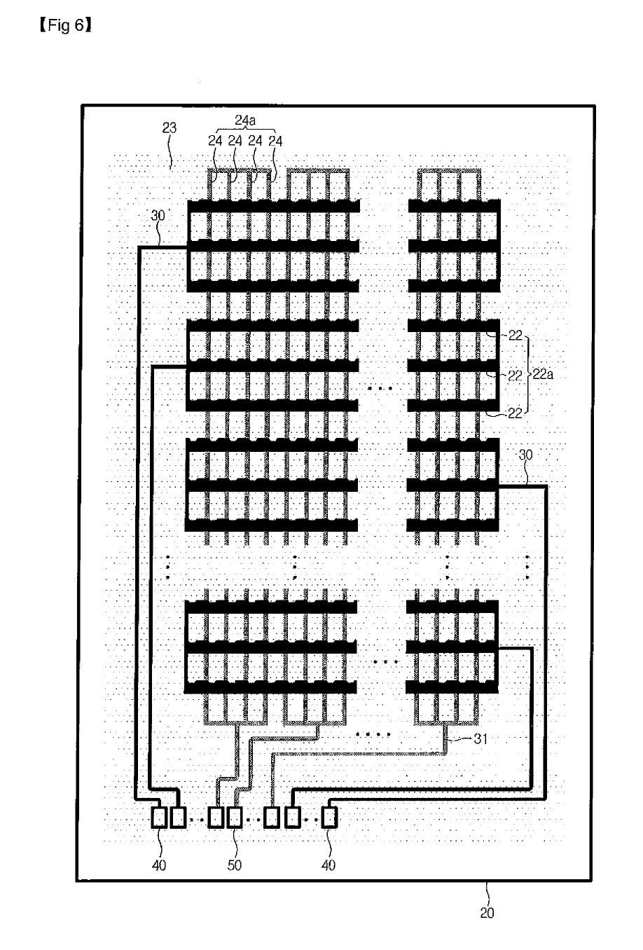

Also, referring to FIG. 6, a metal film is formed on the insulating layer 23 and patterned to form the second touch signal line 24 at a position corresponding to the data line 13 of the first substrate 10, and the second external connector 50 is formed outside the display region. Further, the second fan-out wiring line 31 is formed to electrically connect the second touch signal line 24 with the second external connector 50.

At this time, a preset number of second touch signal lines 24 may be grouped and electrically connected to thereby form the second touch signal line group 24a.

The second fan-out wiring line 31 may be extended so that a first end thereof can be electrically connected to the second touch signal line 24 and a second end thereof can be electrically connected to the second external connector 50.

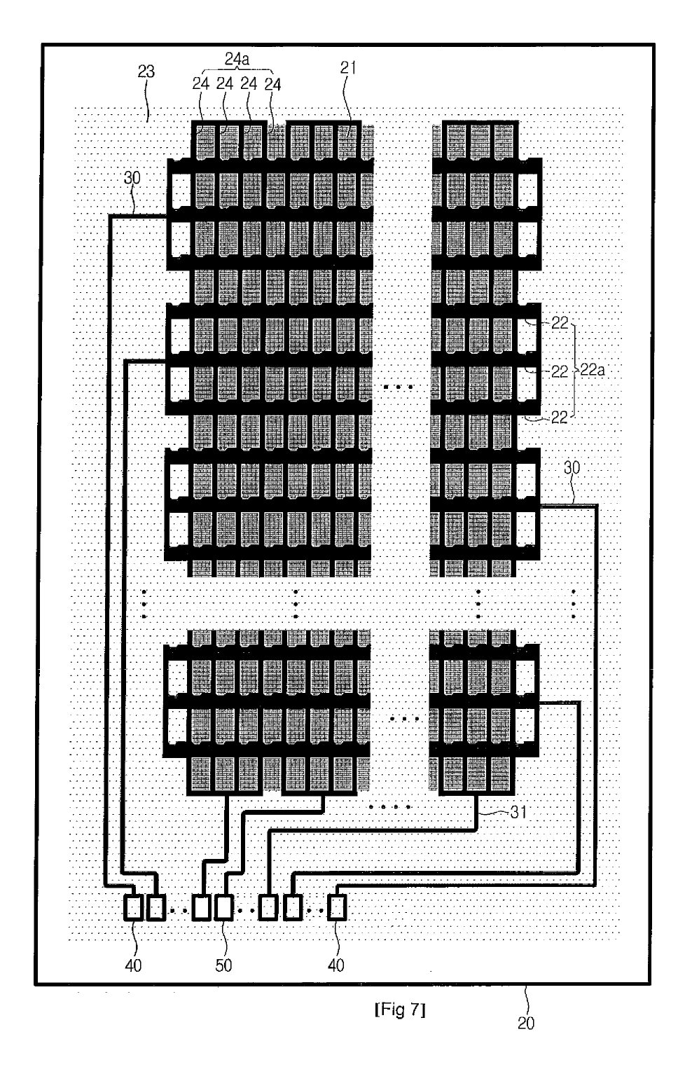

Then, as shown in FIG. 7, the color filter 21 is formed in a region sectioned by the first touch signal line 22 and the second touch signal line 24.

Further, the first and second external connectors 40 and 50 are connected to the pad formed in the first substrate 10 through the conductive transfer, and connected to the driving circuit provided as the FPC or the like connected from the exterior, thereby sensing touch through the first touch signal line 22 and the second touch signal line 24. As described above, the touch signal lines for sensing touch is also serving as the conventional black matrix, so that the LCD apparatus with the built-in touch sensor can be manufactured to be thinner.

Next, an LCD apparatus with a built-in touch sensor according to a second exemplary embodiment of the present invention will be described.

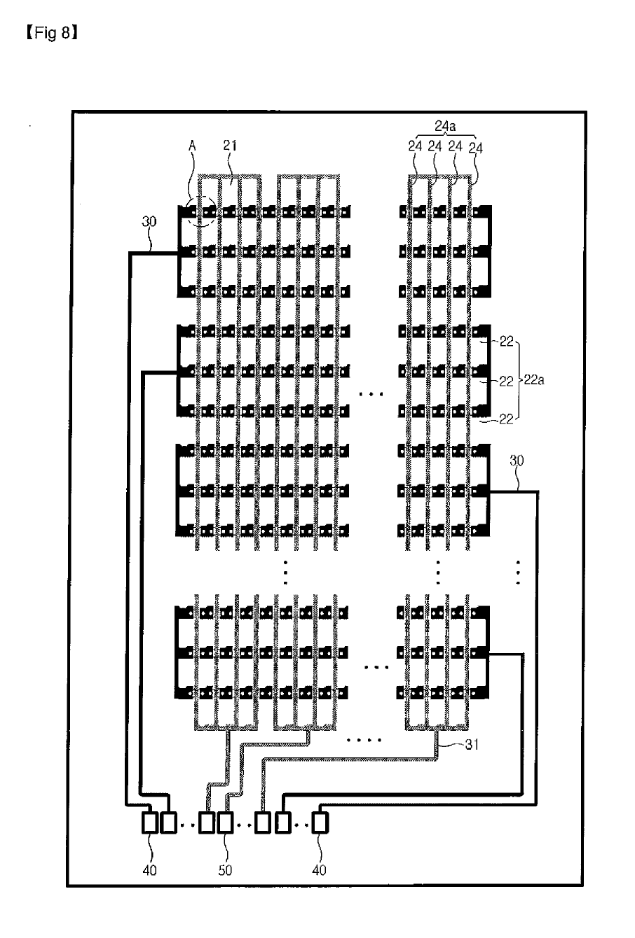

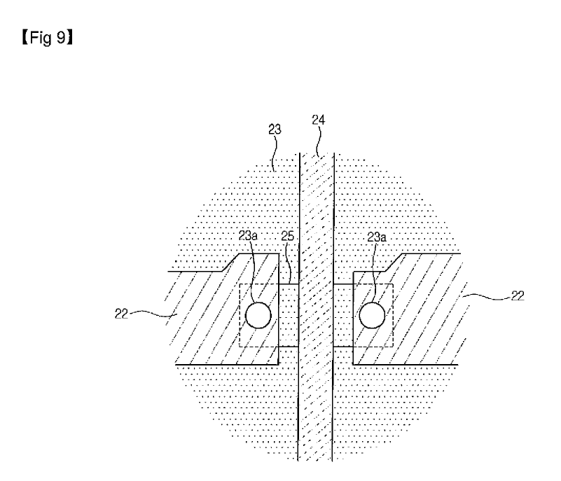

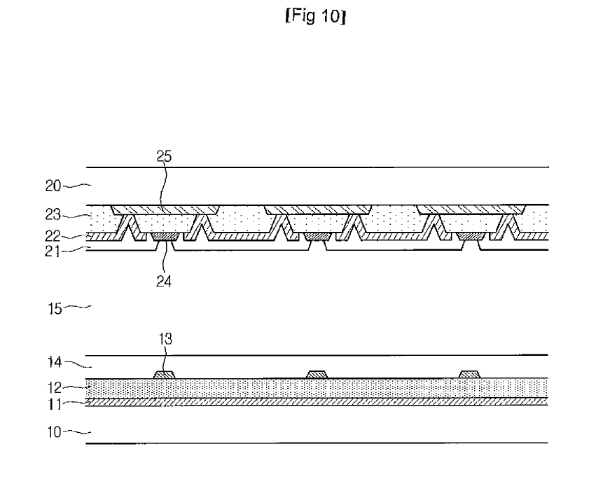

FIG. 8 is a schematic view of an LCD apparatus with a built-in touch sensor according to a second exemplary embodiment of the present invention, FIG. 9 is an enlarged view of ‘A’ in FIG. 8, and FIG. 10 is a cross-section view taken along a gate line in FIG. 8.

Referring to FIGS. 8 to 10, in the LCD apparatus with the built-in touch sensor according to the second exemplary embodiment of the present invention, the first touch signal line 22 and the second touch signal line 24 are formed on one surface, i.e., one layer in the form of a single layer.

Here, the first touch signal line 22 and the second touch signal line 24 may be formed on one layer on a surface of the second substrate 20 opposite to the first substrate 10 at positions respectively corresponding to the gate lines and the data lines like those of the first exemplary embodiment.

At this time, one of the first touch signal line 22 and the second touch signal line 24 is disconnected and segmented not to be electrically connected to each other in the region where the first touch signal line 22 and the second touch signal line 24 intersect with each other.

In this exemplary embodiment, it is illustrated that the first touch signal line 22 is formed as being segmented.

At the same time, the first fan-out wiring line 30 and the second fan-out wiring line 31, and the first external connector 40 and the second external connector 50 are formed to have one ends thereof connected to the first touch signal line 22 and the second touch signal line 24, respectively.

Further, the insulating layer 23 is formed on the entire surface of the second substrate 20 where the first touch signal line 22 and the second touch signal line 24 are formed.

At this time, the insulating layer 23 may be formed with a contact hole 23a through which a part of opposite sides of the first touch signal line 22 segmented with the second touch signal line 24 therebetween.

Further, a conductive bridge electrode 25 is formed to electrically connect the disconnected parts of the first touch signal line 22 in the region where the first touch signal line 22 and the second touch signal line 24 intersect with each other.

Through this, each first touch signal line 22 may be connected to each other and extended in the form of corresponding to the gate line. Other elements except the elements corresponding to the foregoing descriptions are substantially equal to those of the first exemplary embodiment, and thus repetitive descriptions thereof will be avoided.

Next, an LCD apparatus with a built-in touch sensor according to a third exemplary embodiment of the present invention will be described. This exemplary embodiment is equal to the second exemplary embodiment in that the first touch signal line and the second touch signal line are formed on one plane, but different in their stacked structures.

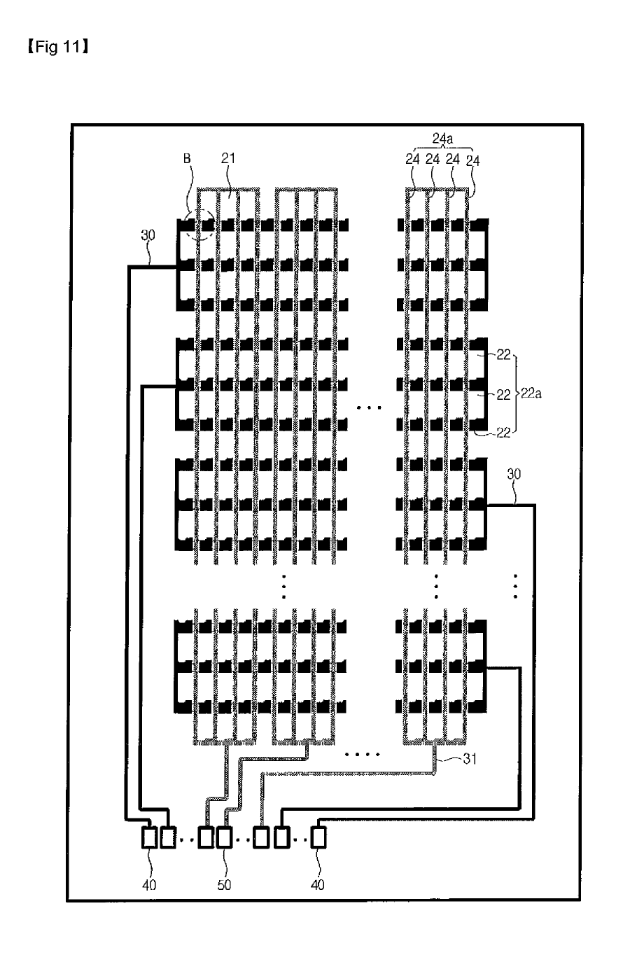

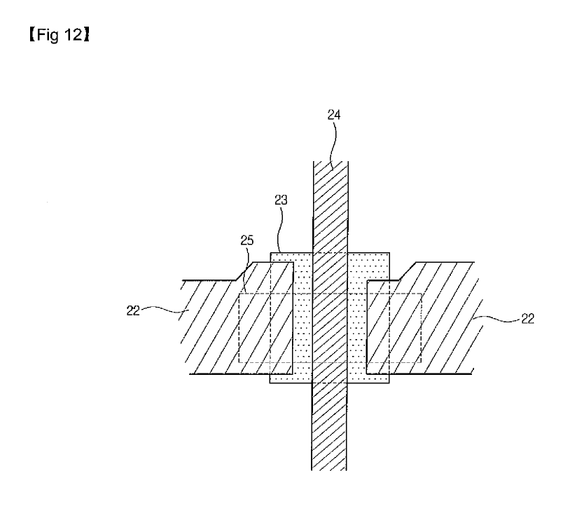

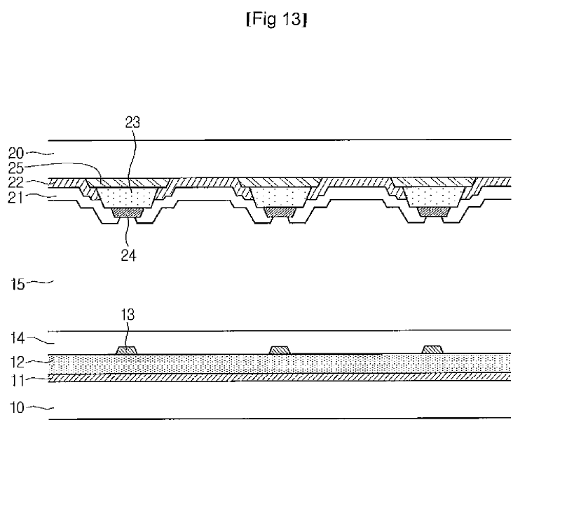

FIG. 11 is a schematic view of an LCD apparatus with a built-in touch sensor according to a third exemplary embodiment of the present invention, FIG. 12 is an enlarged view of ‘B’ in FIG. 8, and FIG. 13 is a cross-section view taken along a gate line in FIG. 11.

Referring to FIGS. 11 to 13, the bridge electrode 25 is first formed at a position corresponding to the region where the first touch signal line 22 and the second touch signal line 24 intersect with each other.

Further, the insulating layer 23 is formed to cover a top portion of the bridge electrode 25 while partially exposing opposite sides of the bridge electrode 25.

At this time, the insulating layer 23 may be provided in the form of an island, and may be formed with no contact hole since the first touch signal line 22 (to be described later) is formed to directly contact the opposite ends of the bridge electrode 25.

Then, the first touch signal line 22 and the second touch signal line 24 are formed on the insulating layer 23 at positions respectively corresponding to the gate line and the data line like those of the second exemplary embodiment.

At this time, one of the first touch signal line 22 and the second touch signal line 24 is disconnected and segmented not to be electrically connected to each other in the region where the first touch signal line 22 and the second touch signal line 24 intersect with each other. In this exemplary embodiment, it is illustrated that the first touch signal line 22 is formed as being segmented.

The first touch signal line 22 segmented with the second touch signal line 24 therebetween is formed to connect with the opposite sides of the bridge electrode 25. Through this, each first touch signal line 22 may be connected to each other and extended in the form of corresponding to the gate line.

At the same time, the first fan-out wiring line 30 and the second fan-out wiring line 31, and the first external connector 40 and the second external connector 50 may be formed to electrically connect with the first touch signal line 22 and the second touch signal line 24, respectively.

Other elements are substantially the same as those of the first and second exemplary embodiments, and thus repetitive descriptions thereof will be avoided.

In the LCD apparatus with the built-in touch sensor according to the foregoing exemplary embodiments, the signal lines for sensing serves as a light shielding member, so that transmittance of the touch panel can be significantly improved as compared with a conventional one.

As described above, there is provided an LCD apparatus with a built-in touch sensor, in which a touch signal line usable as a light shielding member for shielding light and a signal line for sensing touch is formed at a position for a conventional black matrix, thereby enhancing transmittance and simplifying a process.

Further, there is provided an LCD apparatus with a built-in touch sensor, in which there is no need of a separate touch panel and a LCD panel can be made thin since a touch signal line serves as both a light shielding member and a signal line.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A liquid crystal display (LCD) apparatus with a built-in touch sensor, the LCD apparatus comprising:
a first substrate and a second substrate placed facing each other with a liquid crystal layer interposed therebetween;
a plurality of gate lines and a plurality of data lines arranged to intersect each other and defined a pixel region on the first substrate;
a plurality of first touch signal lines formed on a surface of the second substrate opposite to the first substrate substantially corresponding to the respective gate lines;
a plurality of second touch signal lines formed on the surface of the second substrate substantially corresponding to the respective data lines while being insulated from and intersecting with the first touch signal lines; and
a color filter formed on the surface of the second substrate substantially corresponding to the pixel region,
wherein the first touch signal lines and the second touch signal lines serve as a signal line for sensing touch as well as a light shielding member.

2. The LCD apparatus according to claim 1, wherein the first touch signal line and the second touch signal line are respectively formed on different planes with an insulating layer therebetween.

3. The LCD apparatus according to claim 1, wherein the first touch signal line and the second touch signal line are formed on the same plane, and one of the first touch signal line and the second touch signal line is electrically connected by a bridge electrode leaving an insulating layer therebetween in a region where the first touch signal line and the second touch signal line intersect with each other.

4. The LCD apparatus according to claim 3, wherein the bridge electrode is formed on a surface of the second substrate opposite to the first substrate, and the first touch signal line and the second touch signal line are formed under the bridge electrode with the insulating layer therebetween.

5. The LCD apparatus according to claim 3, wherein the first touch signal line and the second touch signal line are formed on a surface of the second substrate opposite to the first substrate, and the bridge electrode is formed under the first touch signal line and the second touch signal line with the insulating layer therebetween.

6. The LCD apparatus according to claim 1, wherein the first touch signal line is electrically connected to at least one different first touch signal line adjacent thereto to form a first touch signal line group, and the second touch signal line is electrically connected to at least one different second touch signal line adjacent thereto to form a second touch signal line group.

7. A method of manufacturing a liquid crystal display (LCD) apparatus with a built-in touch sensor, which comprises a first substrate and a second substrate placed facing each other with a liquid crystal layer interposed therebetween, and a plurality of gate lines and a plurality of data lines arranged to intersect each other and defined a pixel region on the first substrate, the method comprising
forming a plurality of first touch signal lines by stacking and patterning a transparent conductive layer on a surface of the second substrate opposite to the first substrate substantially corresponding to the respective gate lines;
forming an insulating layer to cover the first touch signal line formed on the second substrate;
forming a plurality of second touch signal lines by stacking and patterning a transparent conductive layer on the insulating layer corresponding to the respective data lines while intersecting with the first touch signal; and
forming a color filter on the surface of the second substrate substantially corresponding to the pixel region.

8. A method of manufacturing a liquid crystal display (LCD) apparatus with a built-in touch sensor, which comprises a first substrate and a second substrate placed facing each other with a liquid crystal layer interposed therebetween, and a plurality of gate lines and a plurality of data lines arranged to intersect each other and defined a pixel region on the first substrate, the method comprising
forming a plurality of bridge electrodes spaced part from each other along a direction of the gate line or the data line by stacking and patterning a conductive film on a surface of the second substrate opposite to the first substrate;
forming an insulating layer to cover the bridge electrode and have a contact hole through which opposite sides of the bridge electrode are partially exposed;
forming a first touch signal line and a second touch signal line at positions respectively corresponding to the gate line and the data line by stacking and patterning a transparent conductive layer on the insulating layer, wherein one of the first touch signal line and the second touch signal line is segmented with the other one therebetween, and the segmented touch signal lines are connected to the bridge electrode through the contact hole and thus electrically connected to each other; and
forming a color filter on the surface of the second substrate substantially corresponding to the pixel region.

9. A method of manufacturing a liquid crystal display (LCD) apparatus with a built-in touch sensor, which comprises a first substrate and a second substrate placed facing each other with a liquid crystal layer interposed therebetween, and a plurality of gate lines and a plurality of data lines arranged to intersect each other and defined a pixel region on the first substrate, the method comprising
forming a plurality of bridge electrodes at regular intervals at positions corresponding to the gate line or the data line by stacking and patterning a conductive film on a surface of the second substrate opposite to the first substrate;
forming an insulating layer to cover the bridge electrode while partially exposing opposite sides of the bridge electrode;
forming a first touch signal line and a second touch signal line at positions respectively corresponding to the gate line and the data line by stacking and patterning a transparent conductive layer on a surface of the second substrate formed with the insulating layer, wherein one of the first touch signal line and the second touch signal line is segmented with the other one therebetween, and the segmented touch signal lines are electrically connected to each other through the exposed part of the bridge electrode; and
forming a color filter on the surface of the second substrate substantially corresponding to the pixel region.
